(19) United States
(12) Patent Application Publication
(10) Pub. No.: US 2004/0044569 A1
(43) Pub. Date: Mar. 4, 2004

(54) Systems and method for providing targeted message in a media player

(76) Inventors: William Anthony Roberts, Seattle, WA (US); Bradley John Pitzel, Seattle, WA (US); Brian Todd Burruss, Seattle, WA (US); Stanislav Michailovich Bobrovskiy, Lake Forest Park, WA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/303,492

(22) Filed: Nov. 20, 2002

Related U.S. Application Data
(60) Provisional application No. 60/408,209, filed on Aug. 30, 2002.

(51) Int. Cl. G06F 17/60

(52) U.S. Cl. 705/14

(57) ABSTRACT

Systems and methods for providing targeted messages to users of media presentation systems. In accordance with one embodiment of the invention, a message server may communicate with a media presentation system, such as a media player for streaming video and audio, to present targeted messages to the user of the media presentation system. The targeted messages include messages to promote marketing campaigns, advertising, and the like. The targeted messages may be presented in various formats, including a graphical display, an audio presentation, a graphical and audio presentation, URL links, and/or interactive windows. Information about the media presentation systems and information about the marketing campaigns are maintained by the message server. The message server may update the foregoing information in accordance with the interaction between the message server and the media presentation system.

### REFERENCE TO RELATED APPLICATION

The present application claims priority under 35 U.S.C. §119(e) from U.S. Provisional Application No. 60/408,209 filed Aug. 30, 2002, entitled “SYSTEMS AND METHOD FOR PROVIDING TARGETED MESSAGE IN A MEDIA PLAYER,” which is incorporated herein by reference.

### FIELD OF THE INVENTION

The systems and methods relate to the transmission of media data. More specifically, the invention relates to systems and methods for providing targeted messages to users of media presentation systems.

### BACKGROUND

The distribution of multimedia data, including video, audio, and image data, has become increasingly more effective, efficient, and flexible. Factors contributing to the improvement in distribution of multimedia data include the growing capability of the Internet and the underlying networking infrastructure, the growing capability and affordability of personal computer systems, high-speed access to the Internet by personal computer users, and the capability of efficiently processing multimedia data to provide an engaging and interesting experience for users. Multimedia data sometimes may be preferable to text-only data in conveying content-rich information naturally and intuitively; moreover, advancements in multimedia presentations allow for interaction between the originator of the multimedia data and the viewer of the multimedia data. Additionally, improvements in computer database technology now allow for detailed personal data about the users of the multimedia to be maintained, updated, and accessed at an increasingly greater speed.

Many companies and organizations wish to transmit messages to computer users, typically on a client system, using improvements in multimedia data delivery systems. Client systems may be any device that a user can provide input into, such as but not limited to a PC, cell phone, personal data assistant, television, set top box, telephone, or tablet. However, these messages are often ignored or rejected by the computer users. It may be less likely that these messages would be rejected or ignored if the messages were targeted or designed for the particular computer user receiving the message. Therefore, there is a need for a method of delivering targeted messages to computer users using the advancements in multimedia data delivery and the access to the users' personal information.

### BRIEF DESCRIPTION OF THE DRAWINGS

FIG. 1 illustrates a sample interface of a multimedia client program with a targeted message.

FIG. 2 illustrates a block diagram of a targeted message management system according to aspects of an embodiment of the invention.

FIG. 2A illustrates a block diagram of one embodiment of a targeted message management system that illustrates a sample flow of data among the components.

FIG. 3 illustrates a block diagram of a server system according to aspects of an embodiment of the invention.

FIG. 4 illustrates a block diagram of a client system according to aspects of an embodiment of the invention.

FIG. 5 illustrates a process flow diagram of a server-side message management process according to aspects of an embodiment of the invention.

FIG. 6 illustrates a process flow diagram of a client-side message management process according to aspects of an embodiment of the invention.

FIG. 7 illustrates a block diagram of a decision tree for preparing targeted message according to aspects of an embodiment of the invention.

### DETAILED DESCRIPTION OF PREFERRED EMBODIMENTS

Systems and methods which represent embodiments and example applications of the invention will now be described with reference to the drawings. Variations to the systems and methods which represent other embodiments will also be described. In one disclosed embodiment, the system and method are used to provide targeted messages to users of a multimedia client program or mediate presentation system; however, the present invention is not limited by the type of client program used. Other types of client programs may be used such as, for example, a word processor, a software game, a recipe program, a spreadsheet program, a database program, a tax preparation program, and so forth. The figures and descriptions, however, relate to embodiments of the invention wherein the client program is a multimedia program. It is also recognized that in other embodiments, the systems and methods may be implemented as a single module and/or implemented in conjunction with a variety of other modules and the like.

The features of the systems and methods will now be described with reference to the drawings summarized above. Throughout the drawings, reference numbers are re-used to indicate correspondence between referenced elements. In addition, the first digit of each reference number indicates the figure in which the element first appears. The drawings, associated descriptions, and specific implementation are provided to illustrate embodiments of the invention, and not to limit the scope of the invention. The scope of the invention is defined by the appended claims.

### I. Overview

The present invention relates to systems and methods for providing targeted messages to users of media presentation systems. Generally, a targeted message may be a message that is tailored in some way according to information known about the user receiving the message. A targeted message may contain any message including marketing, advertising, and consumer relations messages. For example, a targeted message may make an offer to the user to enter into or renew a subscription to a service, or to use a service on a trial basis. The message may include a variety of data formats, such as, for example, text, voice, image, audio, video, flash, and so forth. A targeted message may be presented to a user through a presentation. Generally, a presentation may be any object capable of relaying information to a user. Some types of presentations may include a video presentation, an audio presentation, a Flash media presentation, a text or HTML presentation, streaming video and/or audio, web documents, any combination of the above, and the like.

One benefit of this embodiment is that by targeting a message to a particular user, the likelihood that the user will respond to the message increases. Users are more interested in products and services that relate to them. For example, if a user is in a certain profession, the user will be more interested in information, products, and services that relate to that profession. An additional benefit of this embodiment is that users are not presented with messages that they are not interested in. Users are dismayed and frustrated when they are presented with messages that do not relate to or interest them. Further, if users are presented with several messages that don't relate to them, they are more likely to ignore a message that eventually does relate to them. A further benefit of this embodiment is that messages can be presented to users based on a schedule or event. For example, a particular message may be presented to a user every three days, or a message to renew a subscription may be presented once the subscription is due for renewal.

As can be seen in the foregoing, there are many advantages in presenting targeted messages. The example are not meant to limit the possible uses of targeted message or the resulting advantages and benefits.

### II. Sample Client Program and Sample Targeted Message

As noted above, in some embodiments, the client program may be a multimedia client program, though it is recognized that a variety of client programs may be used. The multimedia client program may be any program and/or application that may be used to record and play audio files in a variety of formats, to record and view video and image data, to retrieve and send web documents, and so forth. For example, the multimedia client program may be an audio player, a video player, a web browser, a flash media player, a streaming video player, a streaming audio player, a game application, and so forth as well as any combination of the above.

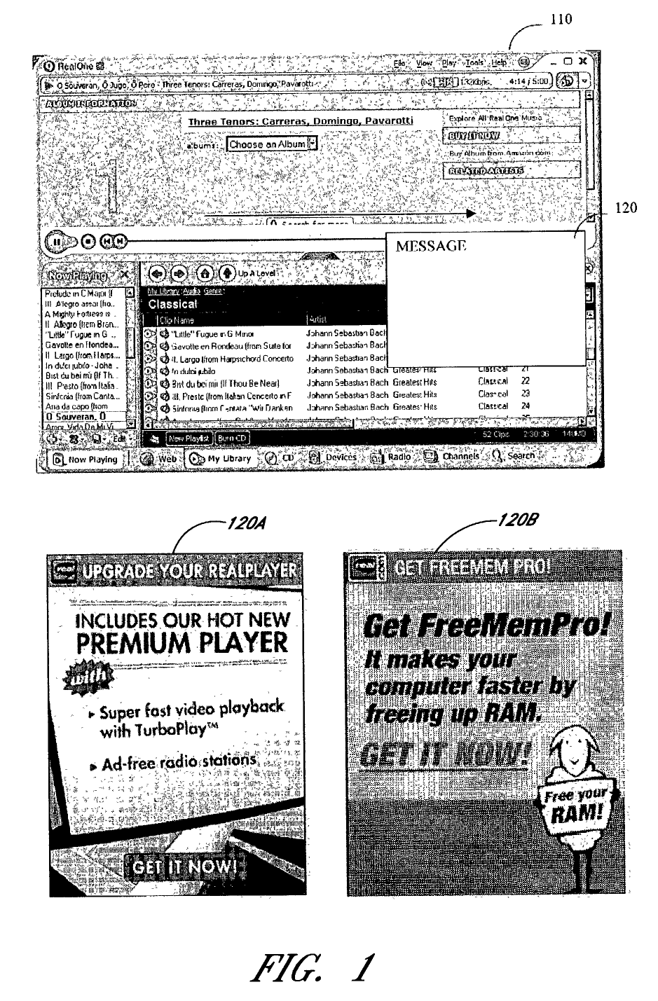

FIG. 1 illustrates an example interface 110 of a multimedia client program as well as a sample targeted message 120. It is recognized that FIG. 1 illustrates one sample multimedia client program interface 110 and that other multimedia client programs or interfaces may be used. Furthermore, the multimedia client program interface 110 may include a variety of features, and those features discussed above are meant only to illustrate sample features. In other embodiments, the multimedia client program interface 110 may provide a variety of targeted messages 120 related to a variety of subjects, such as, for example, advertisements related to the multimedia client program, third party advertisements, messages related to the user's content, messages related to the user's account, and so forth. Targeted messages 120A and 120B may be two samples of the wide variety of possible targeted messages 120.

### III. Targeted Message Management System

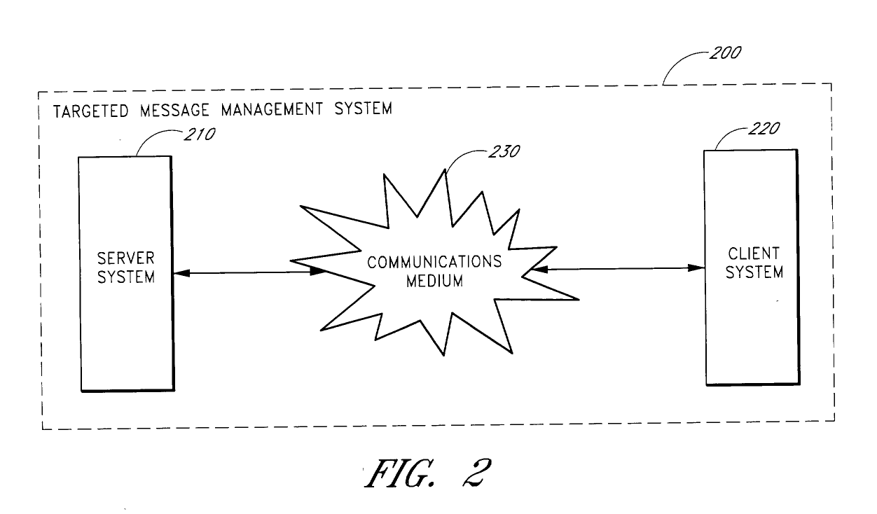

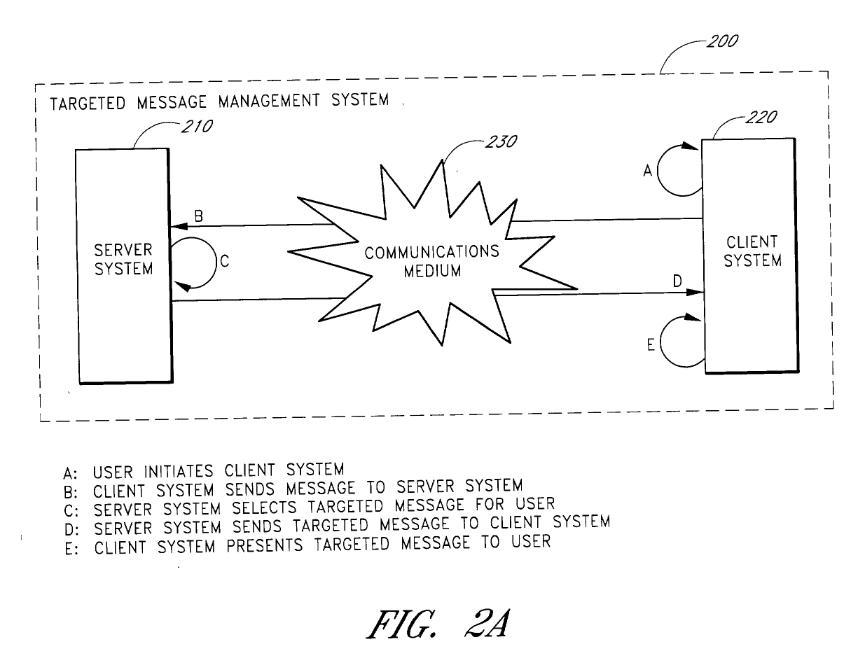

FIG. 2 illustrates a block diagram of a targeted message management system 200, according to aspects of an embodiment of the invention. As illustrated in FIG. 2, the targeted message management system 200 may include a server system 210 and a client system 220 that communicate via a communications medium 230.

FIG. 2A illustrates a sample flow of information between the server system 210 and the user system 220. In event A, the users may initiate the client system, such as, for example, starting the computer, starting the multimedia client program 410, or requesting a piece of multimedia content. The client system may be any computing device such as a general purpose computer using one or more microprocessors, such as, for example, a Pentium processor, a Pentium II processor, a Pentium Pro processor, a Pentium IV processor, an xx86 processor, an 8051 processor, a MIPS processor, a Power PC processor, a SPARC processor, an Alpha processor, and so forth. In event B, the client system 220 may send a message to the server system 210. In event C, the server system 210 may select a targeted message for the user and sends the message to the user system 220 in event D. In event E, the user system 220 may present the targeted message to the user.

A. Server System

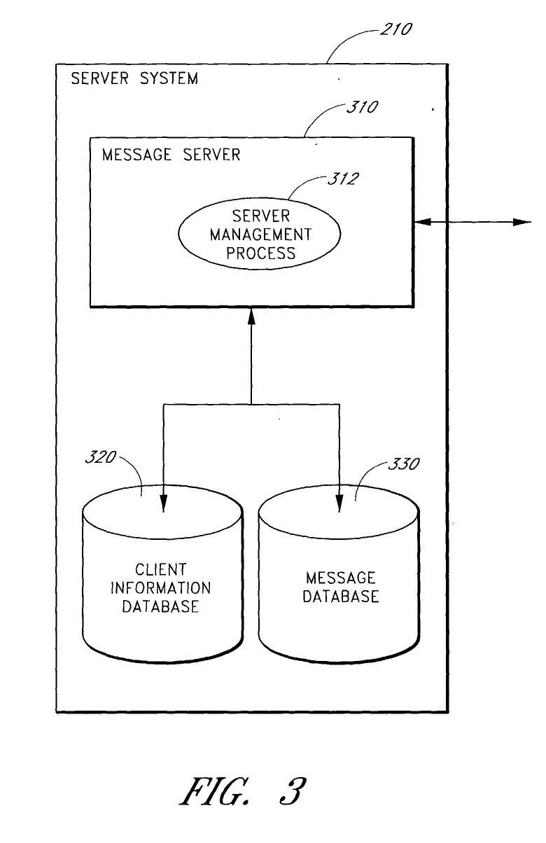

FIG. 3 illustrates a block diagram of the server system 210. The server system 210 may include a message server 310, a client information database 320, and a message database 330.

1. Message Server

In one embodiment, the server system 210 may include the message server 310 used to select and send targeted messages to the client system 220 via the communications medium 230. The message server 310 may include a server management process 312, which is discussed in more detail below in the section entitled “Targeted Message Management Processes.”

In one embodiment, the message server 310 may comprise one or more computer programs executing on a computer server. Generally, a computer server may be a computing device or program that provides some service for other computers connected to it via a network. In one embodiment, the message server 310 execute instructions on a computer that enables the server system 210 to communicate with the client system 220. The computer may be a general purpose computer using one or more processor units, such as, for example, a Pentium® processor, a Pentium II® processor, a Pentium Pro® processor, a Pentium IV® processor, an x86 processor, an 8051 processor, a MIPS processor, a Power PC® processor, a SPARC® processor, an Alpha® processor, and so forth.

In one embodiment, the processor unit may run the Microsoft® Windows 95 operating system and performs standard operating system functions. It is recognized that other operating systems may be used, such as, for example, Microsoft® Windows® 3.X, Microsoft® Windows 98, Microsoft® Windows® 2000, Microsoft® Windows® NT, Microsoft® Windows® XP, Microsoft® Windows® CE, Microsoft® Windows® ME, Palm Pilot OS, Apple® MacOS®, Disk Operating System (DOS), UNIX, IRIX, Solaris, SunOS, FreeBSD, Linux®, IBM® OS/2® operating systems, and so forth.

In one embodiment, the computer may be equipped with conventional network connectivity, such as, for example, Ethernet, Token Ring, Fiber Distributed Datalink Interface (FDDI), or Asynchronous Transfer Mode (ATM). Further, the computer may be configured to support a variety of network protocols such as, for example Network File System (NFS) v2/v3 over (User Datagram Protocol/Transmission Control Protocol) UDP/TCP, Microsoft® Common Internet File Services (CIFS), Hyper Text Transfer Protocol (HTTP) 1.0, HTTP 1.1, File Transfer Protocol (FTP), and so forth.

2. Client Information Database

The client information database 320 stores client information about users of the targeted message management system 200 as well as information about the users' systems. Client information, which may be referred to as a “user profile,” may include information such as, for example, the user's first name, login/password, zip/postal code, gender, age, e-mail address, and payment information, as well as other user identification information. In addition, the information may also include the features for which the users has chosen to enable access as well as features that have been automatically enabled for the user. The information may also include data on the license model or subscription package that the user has purchased indicating what type of content the user may access (e.g., specific artists, specific categories of contents, etc.), as well as the format in which the user may access the content (e.g., streaming, download, etc.). It is recognized, however, that the client information database 320 may store a variety of user information.

As illustrated in FIG. 3, the message server 310 may communicate with the client information database 320. In one embodiment of the invention, the message server 310 communicates with the client information database 320 using an Application Program Interface (“API”). Generally, an API may be an interface, or a defined calling convention, by which an application program accesses the services of another application, such as an operating system. In one embodiment, the communication between the message server 310 and the client information database 330 may be performed using Sequential Query Language (“SQL”) commands. Furthermore, as illustrated in FIG. 3, message server 310 communicates with a message database 330. In one embodiment, the communication between the message server 310 and the message database 330 may be performed using SQL. In other embodiments, the message server 310 may communicate with the message database 330 using other programs, such as, for example, via an API.

3. Message Database

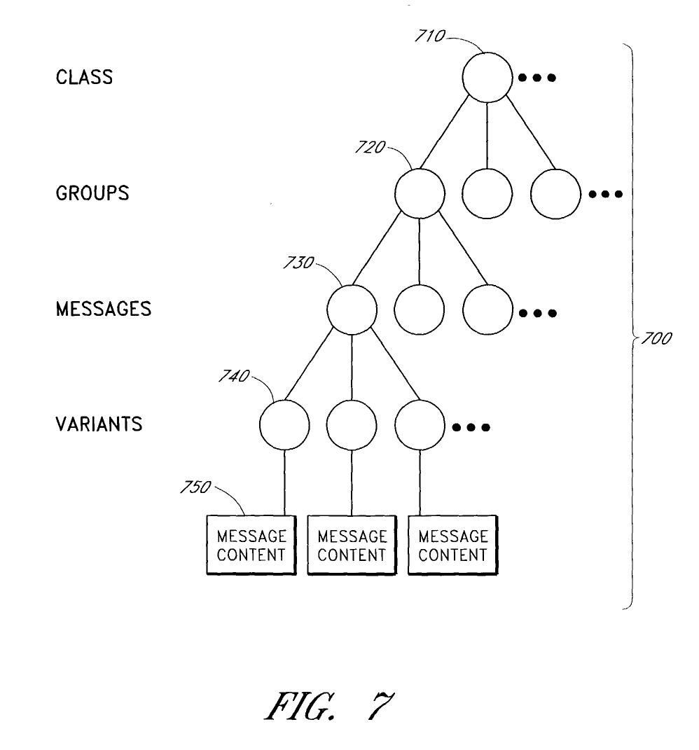

The message database 330 stores information about the messages that are to be presented to the users of the targeted message management system. In one embodiment, the message database 330 advantageously may maintain a decision-making logic for determining the targeted message to be presented to each client system 220. In one embodiment of the invention, the message database 130 may maintain a message database organized in a decision tree structure for determining the targeted message to be presented to each client system 220. In one embodiment of the invention, the message database 130 may further comprise one or more messages to be presented to the client system 220 depending on the result of the operation of the decision-making logic. In another embodiment, the message database 130 may further include references to the location of the messages to be presented to the client system 220. The decision-making logic used in the message database 130 is further illustrated herein with reference to FIG. 7.

In connection with the client information database 320 and the message database 330, there may be several processes (not shown) such as ID generators, number generators, statistic generators, session generators, and temporary storage units that work with the databases. Furthermore, it is recognized that the databases may be implemented using a variety of different databases such as relational databases, flat file databases, and/or object-oriented databases. Moreover, while the databases depicted in FIG. 3 are comprised of two separate databases, it is recognized that in other embodiments, the databases may be implemented as a single database and/or one or both of the databases may include other databases. In addition, one or both of the databases may be implemented as other data structures that are well know in the art such as linked lists, stacks, binary trees, and so forth.

B. Client System

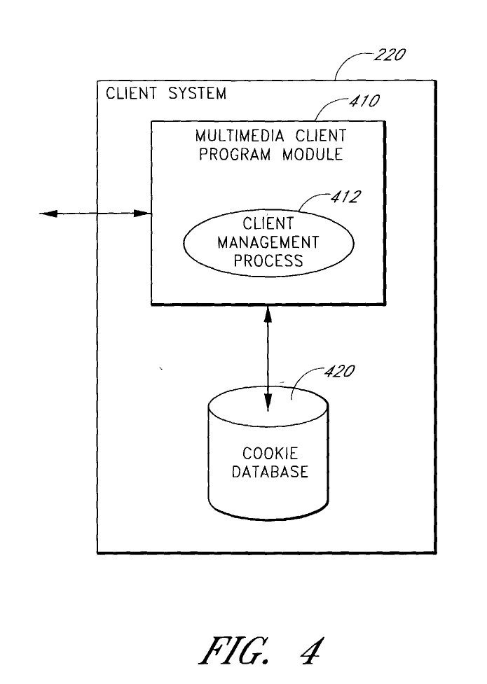

FIG. 4 illustrates one embodiment of the client system 220 illustrated in FIG. 2. The exemplary client system 220 may include a multimedia client program module 410 and a cookie database 420.

As used herein, the word “module”, whether in upper or lower case letters, refers to logic embodied in hardware or firmware, or to a collection of software instructions, possibly having entry and exit points, written in a programming language, such as, for example, C++. A software module may be compiled and linked into an executable program, or installed in a dynamic link library, or may be written in an interpretive language such as BASIC. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein may be preferably implemented as software modules, but may also be represented in hardware or firmware.

1. Multimedia Client Program Module

The multimedia client program module (“multimedia client program”) 410 may permit a user access to a variety of multimedia content. The multimedia content may include, for example, audio data (e.g., analog audio, MP3 files, WAV files, Compact Disks, radio stations, etc.), video data (e.g., DVD, MPEG-4, etc.), image data (e.g., TIFF files, GIF files, JPEG files, etc.), web data (e.g., HTML pages, Java-based web pages, etc.), SMIL content data, streaming flash data, Video Compact Disc data, as well as other types of multimedia data. The multimedia content may be stored on the user computer in a content database (not shown) and/or in a remote location, such as, for example, in a remote database or on a streaming server. In some embodiments, the multimedia client program 410 may include a web browser, whereas in other embodiments, the multimedia client program 410 works in conjunction with a web browser. A web browser may be typically a software program that permits a user to access various web servers, including content providers, through the communications medium 230. The web browser may include the Netscape® Navigator developed by Netscape, Inc. or the Microsoft® Internet Explorer developed by Microsoft Corporation; however, other types of access software may also be used to implement a web browser, such as, for example, other types of Internet browsers, customer network browsers, two-way communications software, cable modem software, point-to-point software, and the like.

The exemplary multimedia client program 410 may include a client management process 412 which is discussed further below in the section entitled “Targeted Message Management Processes.”

In one embodiment, the multimedia client program 410 may include an audio video player, a digital music/video jukebox, and a built-in media browser (not shown). In addition, the multimedia client program 410 provides users with access to a network of multimedia programming such as radio stations, software games, information on current events, sports, entertainment, news, and so forth.

2. Cookie Database

The exemplary cookie database 420 may be a collection of cookie files stored on the client system 220. The cookie files contain small pieces of information, such as user name and preferences, which a server can store with a web browser or other program and later read back from that browser or program. This may be useful for having the multimedia client program 410 and/or a web browser remember specific information from various pages. For example, when a user downloads a program from a web site, the program name, type, and version may be stored in a cookie file so that the client system 220 may maintain information about the downloaded program and can provide such information to remote servers.

In connection with the cookie database 420, there may be several processes (not shown) such as ID generators, number generators, statistic generators, session generators, and temporary storage units that work with the database. Furthermore, it is recognized that the database may be implemented using a variety of different databases in addition to or instead of the cookie database 420, such as relational databases, flat file database, and/or object-oriented databases. Moreover, it is recognized that in other embodiments, the database may be implemented as two or more databases and may include other databases. In addition, the database may be implemented using other data structures that are well know in the art such as linked lists, stacks, binary trees, and so forth.

3. System Information

In one embodiment, the client system 220 may enable the user to communicate with the server system 210 via the communications medium 230. The client system 220 may be a general purpose computer using one or more processors, such as, for example, a Pentium® processor, a Pentium® II processor, a Pentium® Pro processor, a Pentium® IV processor, an x86 processor, an 8051 processor, a MIPS processor, a Power PC processor, a SPARC® processor, an Alpha® processor, and so forth.

In one embodiment, the processor unit may execute the Microsoft® Windows® XP operating system and performs standard operating system functions. It is recognized that other operating systems may be used, such as, for example, Microsoft® Windows® 3.X, Microsoft® Windows 98, Microsoft® Windows® 2000, Microsoft® Windows® NT, Microsoft® Windows® CE, Microsoft® Windows® ME, Palm Pilot OS, Apple® MacOS®, Disk Operating System (DOS), UNIX, IRIX, Solaris, SunOS, FreeBSD, Linux®, IBM® OS/2® operating systems, and so forth.

In one embodiment, the client system 220 may be equipped with conventional network connectivity, such as, for example, Ethernet, Token Ring, Fiber Distributed Datalink Interface (FDDI), or Asynchronous Transfer Mode (ATM). Further, the user computer 220 may be configured to support a variety of network protocols such as, for example NFS v2/v3 over UDP/TCP, Microsoft® CIFS, HTTP 1.0, HTTP 1.1, FTP, and so forth.

C. Communications Medium

Focusing now on the communications medium 230, the presently preferred communication medium 230 may include the Internet made up of routing hubs that comprise domain name system (DNS) servers, as is well known in the art. DNS is a Transfer Control Protocol/Internet protocol (TCP/IP) service translates domain names to and from Internet Protocol (IP) addresses. The routing hubs may connect to one or more other routing hubs via high-speed communication links. One popular part of the Internet is the World Wide Web, which may include different computers which store electronic web documents via their web sites. The term “site” is not intended to imply a single geographic location, as a Web site or other network site can, for example, include multiple geographically distributed computer systems that are appropriately linked together. Generally, the electronic web documents may display a variety of data such as, graphical images, audio, video, and so forth.

One of ordinary skill in the art will recognize that a wide range of interactive communications mediums may be employed in the present invention. For example, the communications medium 230 may include interactive television networks, telephone networks, wireless networks, wireline networks, cellular networks, wireless data transmission systems, two-way cable systems, customized computer networks, interactive kiosk networks, local area networks, wide area networks, satellite networks, intranet networks, broadband networks, baseband networks, and the like as well as any combination of the above.

### IV. Targeted Message Management System Processes

As noted above, in some embodiments, the targeted message management system 100 may include a server management process and a client management process.

A. Server Management Process

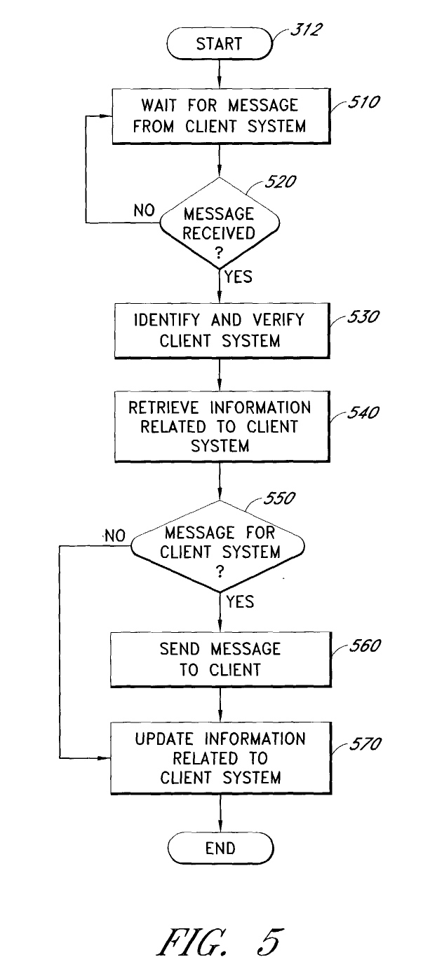

FIG. 5 illustrates a process flow diagram of a server message management process 312, according to aspects of an embodiment of the invention. As illustrated in FIG. 5, beginning at a start state, the server message management process 312 may wait for a client message from a client system 220 (block 510). Next, the server message management process 312 determines if a client message has been received (block 520). If a client message has not been received, the server message management process 312 returns to block 510 and waits for a client message. If a client message has been received, the server message management process 312 identifies the client system 220 based on in formation in the client message (block 530).

Generally, a client message may include any message communicated by the client system to another system or device. The client message may comprise a variety of data, such as data relating to the client system or data not related to the client system. The client message may be communicated in various forms. For example, the message may be encrypted, unencrypted, protected by stenography, and so forth. If the client message is received in encrypted form, the client message may be decrypted. It is recognized that one or more encryption techniques or systems may be used to provide encrypted messages. Common types of encryption systems include Data Encryption Standard and public-key encryption.

After the message has been decrypted (if necessary), the server message management process 312 then verifies the client system 220. In one embodiment, the server message management process 312 may look for a certain data or format in the client message, such as a user ID, to identify the client system 220. In another embodiment, the server message management process 312 may retrieve information regarding the client system 220 from the client information database 320; thereafter, the server message management process 312 identifies the client system 220 by verifying client information in the client message against the client information maintained in the client information database 320. If the server message management process 312 cannot identify the client system 220, the server message management process 312 proceeds to an end state.

After the server message management process 312 identifies the user, the server message management process 312 retrieves client information about the client system 220 (block 540). The server message management process 312 may retrieve information about the client system 220 using a variety of techniques. In one embodiment, client information about the client system 220 may be maintained in the client information database 320. The message server 310 may retrieve client information, such as, for example, through an SQL query submitted to the client information database 320. The SQL query may contain the identification of the client system 220. In another embodiment, the client information about the client system 220 may be maintained in a cookie associated with the client system 220. Generally, a cookie may be a packet of information sent by an HTTP server stored on the client system 220. The client system 220 may then send the cookie back when the client system 220 accesses that server. Cookies may contain any information the server chooses to maintain with the browser. A typical use for cookies may be to authenticate or identify a registered user of a web site without requiring the user to sign in again every time the user accesses the site. In yet another embodiment, client information may be advantageously maintained in two locations, such as both in a cookie and in the client information database 320. By having multiple sources for client information, the message server 310 may obtain client information even though one source of client information is unavailable, such as in the situation where the cookie may be corrupt or the client information database 320 may be inoperative.

It is also advantageous for the server system 210 to maintain client information that would assist in designing and implementing targeted marketing and advertising campaigns. In one embodiment, client information may include the client's email address, user ID, preferred language, country identification, service item, service name, service name expiry date, household income range, birth year, gender, one or more content preferences, and other information about the client. Service item may include a list of content that the client may be entitled to view or to listen to, such as, for example, RealNetworks® content, overnight content, and trial content. Service name may include a list of subscriptions that the client has subscribed to, such as, for example, RealNetworks® GoldPass® subscription and RealNetworks® GoldPass® trial subscription. The service name list may also include the relevant expiration dates for subscriptions. Content preferences may include list of content which the client may be interested in, such as, for example, music, sports, entertainment, news, games, and the like. It is recognized, that a variety of client information may be maintained and the data listed above is meant as example sets of data.

By maintaining information about the client, targeted marketing and advertising campaigns can be designed and implemented. For example, by maintaining information on the household income range of the client, a marketing campaign can advertise expensive consumer products to clients with a higher household income range. Similarly, consumer products or services that are gender-specific may be marketed to clients according to information maintain on their gender. As another example, consumer products or services designed for people of a certain age may be targeted to those people if information one their birth date may be maintained.

After the message server 210 retrieves client information about the client system 220, the server message management process 312 determines whether a targeted message is to be sent to the client system 220. In one embodiment, the server message management process 312 queries the message database 330 to determine whether there may be targeted message for the client system 220. The message server 310 may submit a query, including client information, to the message database 330. The message database 330 receives the client information and determines, through its decision-making mechanism, whether there may be a targeted message that may be sent to the client system 220. The message database 330 may use a variety of techniques, systems, and logic to select and/or prepare a targeted message for the client system 220. In one embodiment, the message database 130 may use a decision tree to select and/or prepare the targeted message. The decision tree system is discussed below in the section entitled “Decision Tree” with reference to FIG. 7.

If there is a message to be sent to the client system, such as, for example, if the message database 330 returns a targeted message, the server message management process 312 may send the targeted message to the client system 220 (block 560). Next, the server message management process 312 updates the client information according to the interaction with the client system 220 (570).

If there is no message to be sent to the client system 220, the server message management process 312 may proceed to block 570 to update the client information.

In one embodiment, the client information may be updated in the location where the client information was maintained. Therefore, if the client information is maintained in a cookie on the client system 220, the message server updates the cookie on the client system 220. If the client information is maintained in the client information database 320, the message server 310 may update the client information in the client information database 320.

In some embodiments, it may be advantageous to update client information according to interaction between the message server 310 and the client system 220. For example, if it is desired to present a particular marketing campaign to a client system up to a maximum of three times, it is advantageous to record the number of times that marketing campaign has been presented to the client system.

After the server message management process 312 has updated the information related to the client system 220, the server message management process 312 proceeds to an end state.

It is recognized that FIG. 5 illustrates one embodiment of a server message management process and that other embodiments may be used. For example, the server message management process 312 may be initiated by the server polling a client system and sending the initial message to the client system.

B. Client Message Management Process

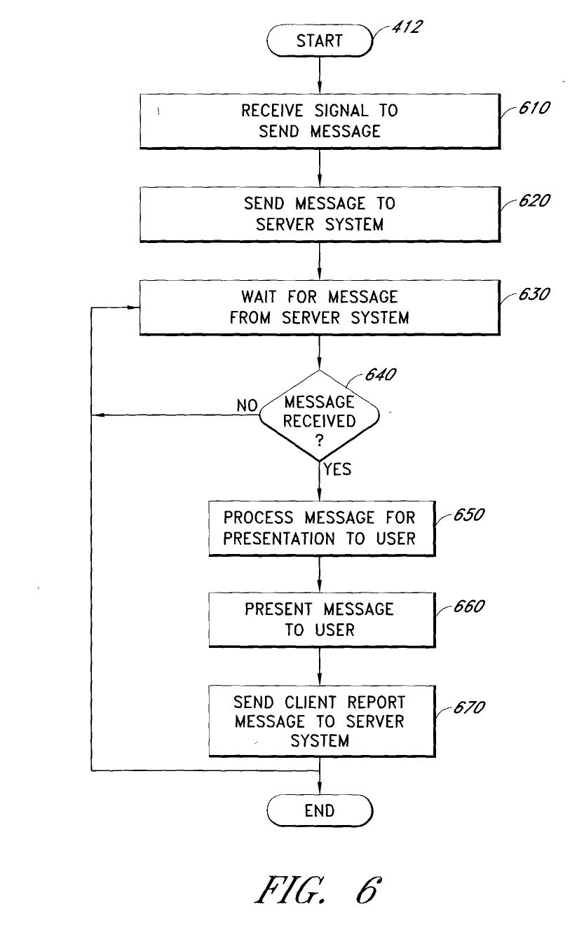

FIG. 6 illustrates a process flow diagram of a client message management process 412 according to aspects of an embodiment of the invention. As illustrated in FIG. 6, beginning at a start state, the client message management process 412 may receive an indication or signal that the client system 220 is to send a message to the server system 210 (block 610). For example, an indication may be sent when the user initiates the multimedia client program. In another embodiment, a scheduling device or system may send the indication that the client system 220 is to send a message the client system 220 to send a client message. The scheduling device or system may include any device or system, such as a computer program, that is capable of prompting another device or system to perform a task. For example, the scheduling system may be a computer program that prompts the client system 220 to send a client message to the server system 210 based on a time interval, such as, for example, every two minutes, every two hours, every three days, every week, and so forth. As another example, the scheduling system may be a computer program that prompts the client system 220 to send a client message based on the occurrence of a certain event, such as, for example, when the client system 220 requests a certain media or file.

Next, the client message management process 412 may send a client message to the message server 310 (block 620). In one embodiment, the client message may include data that identifies the client system 220 to the message server 310. The client system 220 may send the client information in a secure or non-secure format. For example, the message may be encrypted, partially encrypted, or not encrypted at all. In one embodiment, it may be advantageous for the client system 220 to send the client information in encrypted format to protect the information about the client system 220 from misuse by a third party in case such information is intercepted.

The client message management process 412 may then permits the client system 220 to continue operation while the client message management process 412 waits for a message from the server system 210 (block 630). For example, if the user of the client system 220 is viewing streaming media, the streaming media will continue to be presented to the user while the client message management process 412 waits for a targeted message. If the client system 220 is terminated or ceases to operate, the client message management process 412 may proceed to an end state.

Next, the client message management process 412 determines if a client message has been received (block 640). For example, the client message management process 412 may periodically check for targeted messages. As another example, the client message management process 412 may be alerted by arrival of the targeted message.

If the client message management process 412 determines that a targeted message has not arrived, the client message management process 412 returns to block 630. If client message management process 412 determines that a targeted message has arrived, the client message management process 412 may convert the targeted message into a format that can be presented to the user of the client system 220 (block 650). The presentation may take a variety of forms, such as, for example, an audio/visual presentation, a graphical presentation, and Hypertext Markup Language (“HTML”) presentation. As another example, the client system 220 may present one or more Uniform Resource Locator (“URL”) links for the user to pursue if interested. As another example, the user may be presented with a graphical screen containing an advertisement while also presenting the user with an opportunity to accept the advertisement offer by performing an action, such as by clicking on the screen or on a portion of the screen.

Next, the client message management process 412 may present the targeted message to the user and manages the, user's interaction (if any) the with the presentation (block 660). For example, if the user desires to terminate or ignore the presentation, the client message management process 412 terminates the presentation. As another example, if the user desires to accept the presentation offer, the client message management process 412 may facilitate any desired resulting action, such as by presenting a URL included in the presentation.

After the presentation of the message to the user, client message management process 412 sends a client report message based on the user's interaction with the presentation to the message server 310 (block 670). For example, if the user terminated or ignored the presentation, the client message management process 412 may send a client report message to the message server 310 indicating the nature of the user's interaction with the presentation. Similarly, if the user accepts the offer in the presentation, the client message management process 412 may send a client report message to the message server 310 indicating the nature of the user's interaction with the presentation.

Next, the client message management process 412 returns to block 630 to wait for another targeted message from the server system 210.

If the client system 220 and/or the multimedia client program 410 is terminated or ceases to operate, the client message management process 412 may proceed to an end state.

It is recognized that FIG. 6 illustrates one embodiment of a client message management process and that other embodiments may be used. For example, the client message management process 412 may require the server to initiate contact with the client system by polling the client system and sending the initial message to the client system.

### V. Decision Tree

FIG. 7 illustrates a block diagram of a sample decision tree 700 for preparing a targeted message according to aspects of an embodiment of the invention. Generally, a decision tree may be a tree-like diagram or form of logic that is used for making decisions in business or computer programming. The nodes in a decision tree represent a decision to be made, the leaves represent possible outcomes to the decision, and therefore, the branches represent choices with associated results or probabilities. As illustrated in FIG. 7, in one embodiment of the invention, a decision tree may be used to determine the targeted message to be communicated to the client system 220. Information obtained about the client system 220 may be used with the decision tree to determine the-targeted message to be communicated to the client system 220.

In one embodiment, the decision tree may have nodes for “class”, “group”, “message”, and “variant”. In one embodiment, class may be the root node of the tree. The attribute associated with “class” should be chosen such that a high number of client requests can be pruned from the decision tree at this level. An example of class may be “language”, such as a user's preferred language. The group node may be another decision point in the tree. An example of a group node may be message “category”, such as software updates or news. Multiple levels of groups may be added, depending upon implementation. The attribute associated with “group” should also be chosen such that a high number of client requests can be pruned from the decision tree.

At a first decision level, 710, the user's class may be considered. For example, the user's preferred language may be considered. Once the appropriate class is found, the decision branch then moves to the node below the class node, at a second decision level 720. At the second decision level 720 group may be considered. In this example, the list of the categories to which the user may be subscribed may be considered. The system loops through each category as it traverses the remainder of the subordinate decision tree nodes. There may be multiple messages to return to the client for each category to which the user may be subscribed. Once the node representing the desired category is found, the decision branch moves to the node below the category node, at a third decision level 730 where messages are considered. Each message node beneath a category may be considered in sequence. By viewing the client information, the message database 330 can determine which message has been presented to the user, and thus, select a message that has not been presented. Additional targeting decision logic may be executed at the message level, in which attributes such as subscription names, media viewership authorization, and client operating system can be evaluated. Essentially, any attribute of client information not yet considered at a higher level in the decision tree can be evaluated at the message level. Once the node representing the desired message is found, the decision branch moves to the node below the message node, at a fourth decision level 740 where variants are considered.

In some embodiments, it is advantageous to have several variants, which are selected randomly. Each variant presents the same message with a different graphical representation or marketing tag line, for example. The success of variants can be tracked during a trial period. After the end of a trial period, any variants that were not successful can be removed and the most successful variant can be delivered to remaining users. A variant may be associated with a message content 750. In one embodiment, the variant may be associated with the message content 750 through a pointer or a reference mechanism. The targeted message that will be presented to the client system 220 comprises the message content 750 selected by the logic of the decision tree. Thus, once a variant is selected, the decision tree has determined the targeted message. The message content 750 may take any form capable of maintaining or referencing data, such as, for example, a computer file. Once the message content 750 is determined, the message content 750 is communicated to the message server 310 for presentation to the client system 220.

After the message server 310 receives the targeted message from the message database 330, the message server 310 sends the targeted message to the client system 220. After the client system 220 receives the targeted message, the client system 220 presents the targeted message to the user of the client system 220. The client system 220 may present the targeted message through software, such as a media presentation system, present on the client system 220. For example, the targeted message may be presented to the user within a pop-up screen or within an HTML message. As other examples, the targeted message may be presented as a URL or a computer file.

It is recognized that FIG. 7 illustrates one embodiment of a decision tree and that other sets of logic may be used to determine whether a message may be sent to a user. Furthermore, it is recognized that other data structures may be used to store the rules for presenting messages, such as, for example, a binary tree, a graph, a stack, and so forth.

### VI. Sample Operation

### A. Sample 1

A sample operation of one embodiment of the systems and methods will now be described, though it is recognized that the sample operation illustrates only an example implementation of the systems and methods and that other implementations may be used.

Company is offering three subscription packages relating to audio content for use with Company's audio player.

| | |
|---|---|
| Gold: | 150 downloads per month |
| | $20.00 per month |
| Silver: | 50 downloads per month |
| | $10.00 per month |
| Bronze: | 15 downloads per month |
| | $5.00 per month |

Users can sign-up for a subscription package, download the audio player, and utilize the program to listen to audio files.

User Angela downloaded Company's audio player a year ago and had signed up for the Gold package. When Angela downloaded the audio player, she created a login/password, selected the Gold package, and submitted her credit card information. Angela also submitted additional information such as her preference for English, that she is a female, she is in the 25-30 age category, and she likes the Dixie Chicks. About six (6) months ago, Angela decided to switch to the Bronze package.

When Angela uses the audio player, the audio player sends a message to the server that helps to identify Angela to the server. The server then selects a targeted message for Angela. For example, the server may select a message that states that the Dixie Chicks are releasing their new album in one month and may include a URL link to a web site where the album may be purchased. In another example, the server may select a message that states that because Angela was a former Gold member, she has the opportunity to have a fourteen (14) day trial Gold membership. The server sends the message to Angela's computer and the audio player presents the message to Angela.

If Angela clicks on the URL for the new Dixie Chicks album, the audio player may then present Angela with the web page of a web site from which she can purchase the album.

### B. Sample 2

A sample operation of one embodiment of the systems and methods will now be described, though it is recognized that the sample operation illustrates only an example implementation of the systems and methods and that other implementations may be used.

Company is offering a single subscription package relating to audio & video content for use with Company's media player.

Gold: $20.00 per month.

Users can sign-up for a subscription package, download the media player, and utilize the program to listen to media files.

User Angela downloaded Company's media player a year ago and had signed up for the Gold package. When Angela downloaded the audio player, she created a login/password, selected the Gold package, and submitted her credit card information. Three months after Angela purchased the subscription, her credit card company declined monthly payment, because Angela's credit card had expired. When Angela uses the audio player after her credit card has expired and she cannot be billed, the media player sends a message to the server that helps to identify Angela to the server. The server then selects a targeted message for Angela. In this sample, the server can send Angela a message indicating the her credit card has expired and needs to be re-authorized to continue her subscription service. Angela can click on a URL in the message to visit company's e-commerce site to enter updated credit card information.

### C. Sample 3

A sample operation of one embodiment of the systems and methods will now be described, though it is recognized that the sample operation illustrates only an example implementation of the systems and methods and that other implementations may be used.

User Angela downloaded Company's media player a year ago. When Angela downloaded the audio player, she created a login/password. Angela did not purchase any media subscription products from company. Angela later signed up for a message category called “news headlines”. Angela also submitted additional information such as her home Internet connection bandwidth, e.g., cable modem. When Angela uses the audio player the media player may send a message to the server that helps to identify Angela to the server. The server then selects a targeted message for Angela. In this sample, the server has four messages available in the “news headlines” category: (1) a broadband clip for cable modem users of media that can only be viewed by authorized subscription holders; (2) a low bandwidth clip of media that can only be viewed by authorized subscription holders; (3) a broadband clip for cable modem users of media that can only be viewed users who do not own a subscription; and (4) a low bandwidth clip of media that can only be viewed users who do not own a subscription. The server then selects a targeted message for Angela. In this sample, the server sends Angela the message described in item (3) above, because Angela has a cable modem Internet connection and Angela does not own a subscription.

### VII. Conclusion

While the foregoing detailed description has shown, described and identified several novel features of the invention as applied to preferred embodiments, it will be understood that various omissions, substitutions and changes in the form and details of the described embodiments may be made by those skilled in the art without departing from the spirit of the invention. Accordingly, the breadth and scope of the invention should not be limited to the foregoing discussion, but should be defined by the appended claims and their equivalents.

What is claimed is:

1. A method of managing targeted messages, the method comprising:
maintaining client information associated with a client system;
maintaining one or more presentations to be presented to the client system;
retrieving the client information associated with a client system; and
preparing a targeted message according to the client information and the one or more presentations.

2. The method of managing targeted messages of claim 1, further comprising receiving a client message from the client system.

3. The method of managing targeted messages of claim 1, further comprising sending the targeted message to the client system.

4. The method of managing targeted messages of claim 1, further comprising updating the client information based on the client message and the targeted message.

5. The method of managing targeted messages of claim 1, wherein the targeted message includes marketing or advertising data.

6. The method of managing targeted messages of claim 1, wherein the client information is maintained on the client system.

7. The method of managing targeted messages of claim 1, wherein the client information is maintained on a server.

8. The method of managing targeted messages of claim 1, wherein the targeted message includes data on subscription enrollment or renewal.

9. A method of presenting a targeted message to a user of a computer system, the method comprising:
sending client information associated with the computer system to a message server;
receiving the targeted message from the message server; and
presenting the targeted message to the user.

10. The method of managing targeted messages of claim 9, further comprising maintaining client information within the computer system.

11. The method of managing targeted messages of claim 9, wherein the targeted message includes marketing or advertising data.

12. The method of managing targeted messages of claim 9, further comprising the step of sending to the message server information associated with interaction between the user and the targeted message.

13. The method of managing targeted messages of claim 9, wherein the targeted message includes data on subscription enrollment or renewal.

14. The method of managing targeted messages of claim 9, wherein sending the client information to the message server occurs after the occurrence of an event.

15. The method of managing targeted messages of claim 14, wherein the event comprises the start of operation of the client system.

16. The method of managing targeted messages of claim 14, wherein the event includes a scheduled event.

17. A method of presenting targeted messages, the method comprising:
maintaining client information associated with a client system;
maintaining one or more presentations;
communicating the client information to a server;
preparing the targeted message according to the client information and the presentations;
communicating the targeted message to the client system; and
presenting the targeted message to a user of the client system.

18. The method of presenting targeted messages of claim 17, further comprising updating the client information based on the client information and the targeted message.

19. The method of presenting targeted messages of claim 17, wherein the targeted message contains marketing or advertising data.

20. The method of presenting targeted messages of claim 17, wherein the client information is maintained on the client system.

21. The method of presenting targeted messages of claim 17, wherein the client information is maintained on the server.

22. The method of presenting targeted messages of claim 17, wherein the targeted message includes data on subscription enrollment or renewal.

23. The method of presenting targeted messages of claim 17, wherein the step of communicating the client information to the server occurs upon the occurrence of an event.

24. A computer message management system, comprising:
a client identification record;
a client system configured to present media to a user of the client system and to communicate the client identification record;
a user record comprising information associated with the user of the client system;
a client information database configured to manage the user record;
a targeted message comprising data for presentation on the client system;
a message database configured to manage the targeted message; and
a server system configured to receive the client identification record from the client system, to retrieve the user record from the client information database, to communicate the user record to the message database, to retrieve the targeted message from the message database, and to communicate the targeted message to the client system.

25. The computer message management system of claim 24, wherein the targeted message comprises marketing or advertising data.

26. The computer message management system of claim 24, wherein the client system is further configured to communicate the client identification record upon the occurrence of an event.

27. A computer message management system, comprising:
a client identification record;
a media presentation system configured to present a media; and
a client system configured to communicate the client identification record, to receive the media, and to operate the media presentation system to present the media data to a user of the client system.

28. The computer message management system of claim 27, wherein the media comprises marketing or advertising data.

29. The computer message management system of claim 27, wherein the client system is further configured to communicate the client identification record upon the occurrence of an event.

30. A computer message management system, comprising:
a user record comprising information associated with a user of a client system;
a client information database configured to manage the user record;
a targeted message comprising data for presentation on the client system;
a message database configured to manage the targeted message; and
a server system configured to retrieve the user record from the client information database, to communicate the user record to the message database, to retrieve the targeted message from the message database, and to communicate the targeted message to the client system.

31. The computer message management system of claim 30, wherein the targeted message comprises marketing or advertising data.

32. The computer message management system of claim 30, wherein the message database is further configured to select the targeted record from one or more targeted records according to information in the user record.

33. A computer readable medium having stored therein a software module, which when executed performs the steps of:
maintaining client information associated with a client system;
maintaining one or more presentations to be presented to the client system;
retrieving the client information associated with a client system; and
preparing a targeted message according to the client information and the one or more presentations.

34. The software module of claim 33, further comprising receiving a client message from the client system.

35. The software module of claim 33, further comprising sending the targeted message to the client system.

36. The software module of claim 33, further comprising updating the client information based on the client message and the targeted message.

37. The software module of claim 33, wherein the targeted message includes marketing or advertising data.

38. The software module of claim 33, wherein the client information is maintained on the client system.

39. The software module of claim 33, wherein the client information is maintained on a server.

40. The software module of claim 33, wherein the targeted message includes data on subscription enrollment or renewal.

41. A computer readable medium having stored therein a software module, which when executed performs the steps of:
sending client information associated with a computer system to a message server;
receiving a targeted message from the message server; and
presenting the targeted message to a user of the computer system.

42. The software module of claim 41, further comprising maintaining client information within the computer system.

43. The software module of claim 41, wherein the targeted message includes marketing or advertising data.

44. The software module of claim 41, further comprising the step of sending to the message server information associated with interaction between the user and the targeted message.

45. The software module of claim 41, wherein the targeted message includes data on subscription enrollment or renewal.

46. The software module of claim 41, wherein sending the client information to the message server occurs after the occurrence of an event.

47. The software module of claim 46, wherein the event comprises the start of operation of the client system.

48. The software module of claim 46, wherein the event includes a scheduled event.

49. A computer readable medium having stored therein a software module, which when executed performs the steps of:
maintaining client information associated with a client system;
maintaining one or more presentations;
communicating the client information to a server;
preparing a targeted message according to the client information and the presentations;
communicating the targeted message to the client system; and
presenting the targeted message to a user of the client system.

50. The software module of claim 49, further comprising updating the client information based on the client information and the targeted message.

51. The method of presenting targeted messages of claim 49, wherein the targeted message contains marketing or advertising data.

52. The software module of claim 49, wherein the client information is maintained on the client system.

53. The software module of claim 49, wherein the client information is maintained on the server.

54. The software module of claim 49, wherein the targeted message includes data on subscription enrollment or renewal.

55. The software module of claim 49, wherein the step of communicating the client information to the server occurs upon the occurrence of an event.
